(19) United States
(12) Patent Application Publication
(10) Pub. No.: US 2023/0097838 A1
(43) Pub. Date: Mar. 30, 2023

(54) SYSTEM AND METHOD OF DETERMINING RESOURCE UTILIZATIONS OF VIRTUAL MACHINES

(71) Applicant: Dell Products L.P., Round Rock, TX (US)

(72) Inventors: Shivendra Katiyar, Bangalore (IN); Rishi Mukherjee, Bangalore (IN); Ravishankar N. Kanakapura, Bangalore (IN)

(21) Appl. No.: 17/448,742

(22) Filed: Sep. 24, 2021

(51) Int. Cl. G06F 9/455; G06F 9/48

(52) U.S. Cl. CPC G06F 9/45558; G06F 9/4856; G06F 2009/4557; G06F 2009/45591

(57) ABSTRACT

In one or more embodiments, one or more systems, one or more methods, and/or one or more processes may: monitor, by a management console, power consumption of a virtual machine (VM) executed by a first hypervisor on a first physical information handling system (IHS); migrate, by the management console, the VM from the first hypervisor to a second hypervisor on a second physical IHS; provide, by the first hypervisor, VM migration information to the management console; determine, by the management console, if the second hypervisor has been discovered based at least on the VM migration information; if so, refresh a hypervisor inventory to include identification information associated with the second hypervisor; if not, discover the second hypervisor; detect the VM; associate the VM with the second hypervisor; and monitor, by the management console, the power consumption of the VM executed by the second hypervisor on the second physical IHS.

### BACKGROUND

### Field of the Disclosure

This disclosure relates generally to information handling systems and more particularly to determining resource utilizations of virtual machines.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, a system may include multiple physical information handling systems coupled to a network. For example, an administrator physical information handling system of the multiple physical information handling systems may be configured with a management console, which may be configured to: monitor power consumption of a virtual machine executed by a first hypervisor on a first physical information handling system of the multiple information handling systems; and migrate the virtual machine from the first hypervisor to a second hypervisor on a second physical information handling system of the multiple physical information handling systems. For instance, the first hypervisor may be configured to provide virtual machine migration information to the management console. In one or more embodiments, the management console may be further configured to: determine if the second hypervisor has been discovered based at least on the virtual machine migration information; if the second hypervisor has been discovered, refresh a hypervisor inventory to include identification information associated with the second hypervisor; if the second hypervisor has not been discovered, discover the second hypervisor; detect the virtual machine; associate the virtual machine with the second hypervisor; and monitor the power consumption of the virtual machine executed by the second hypervisor on the second physical information handling system. In one or more embodiments, the system may include the network.

In one or more embodiments, the second physical information handling system may include a baseboard management controller. For example, to monitor the power consumption of the virtual machine executed by the second hypervisor, the management console may be further configured to receive, from the baseboard management controller, power consumption information of the second physical information handling system. In one or more embodiments, to monitor the power consumption of the virtual machine executed by the second hypervisor, the management console may be further configured to determine the power consumption of the virtual machine executed by the second hypervisor based at least on the power consumption information of the second physical information handling system. For example, to determine the power consumption of the virtual machine executed by the second hypervisor based at least on the power consumption information of the second physical information handling system, the management console may be further configured to determine the power consumption of the virtual machine executed by the second hypervisor based at least on a first portion of power of a physical processor of the second physical information handling system utilized by the virtual machine and a second portion of power of physical memory of the second physical information handling system utilized by the virtual machine.

In one or more embodiments, the baseboard management controller may include: at least one processor; and a memory medium, coupled to the at least one processor, that stores instructions executable by the at least one processor, which when executed by the at least one processor, may cause the baseboard management controller to: determine the power consumption information of the second physical information handling system. For example, the baseboard management controller may be communicatively coupled to multiple busses of the second physical information handling system. For instance, to determine the power consumption information of the second physical information handling system, the instructions may further cause the baseboard management controller to: receive information from at least one of the multiple busses; and determine the power consumption information of the second physical information handling system based at least on the information from the at least one of the multiple busses.

In one or more embodiments, the virtual machine migration information may include the identification information associated with the second hypervisor. For example, to determine if the second hypervisor has been discovered based at least on the virtual machine migration information, the management console may be further configured to determine if the hypervisor inventory includes the identification information associated with the second hypervisor. In one or more embodiments, the management console may be further configured to: determine that the second hypervisor is not configured to supply virtual machine metrics associated with the virtual machine; and in response to determining that the second hypervisor is not configured to supply the virtual machine metrics associated with the virtual machine, configure hypervisor setting of the second hypervisor to supply the virtual machine metrics associated with the virtual machine. In one or more embodiments, the management console may be further configured to: determine that the second hypervisor is not capable of determining power consumption data associated with the virtual machine; and in response to determining that the second hypervisor is not capable of determining the power consumption data associated with the virtual machine, install an agent on the second hypervisor to collect the power consumption data associated with the virtual machine.

In one or more embodiments, one or more systems, one or more methods, and/or one or more processes may monitor, by a management console, power consumption of a virtual machine executed by a first hypervisor on a first physical information handling system; may migrate, by the management console, the virtual machine from the first hypervisor to a second hypervisor on a second physical information handling system; may provide, by the first hypervisor, virtual machine migration information to the management console; may determine, by the management console, if the second hypervisor has been discovered based at least on the virtual machine migration information; if the second hypervisor has been discovered, may refresh a hypervisor inventory to include identification information associated with the second hypervisor; if the second hypervisor has not been discovered, may discover the second hypervisor; may detect the virtual machine; may associate the virtual machine with the second hypervisor; and may monitor, by the management console, the power consumption of the virtual machine executed by the second hypervisor on the second physical information handling system.

In one or more embodiments, monitoring the power consumption of the virtual machine executed by the second hypervisor may include receiving, from a baseboard management controller of the second physical information handling system, power consumption information of the second physical information handling system. For example, monitoring the power consumption of the virtual machine executed by the second hypervisor may include determining the power consumption of the virtual machine executed by the second hypervisor based at least on the power consumption information of the second physical information handling system. For instance, determining the power consumption of the virtual machine executed by the second hypervisor based at least on the power consumption information of the second physical information handling system may include determining the power consumption of the virtual machine executed by the second hypervisor based at least on a first portion of power of a physical processor of the second physical information handling system utilized by the virtual machine and a second portion of power of physical memory of the second physical information handling system utilized by the virtual machine.

In one or more embodiments, the one or more systems, the one or more methods, and/or the one or more processes may further determine, by the baseboard management controller, the power consumption information of the second physical information handling system. For example, the baseboard management controller may be communicatively coupled to multiple busses of the second physical information handling system. For instance, determining the power consumption information of the second physical information handling system may include: receiving, by the baseboard management controller, information from at least one of the multiple busses; and determining, by the baseboard management controller, the power consumption information of the second physical information handling system based at least on the information from the at least one of the multiple busses.

In one or more embodiments, the virtual machine migration information may include the identification information associated with the second hypervisor. For example, determining if the second hypervisor has been discovered based at least on the virtual machine migration information may include determining if the hypervisor inventory includes the identification information associated with the second hypervisor. In one or more embodiments, the one or more systems, the one or more methods, and/or the one or more processes may further determine that the second hypervisor is not configured to supply virtual machine metrics associated with the virtual machine. For example, in response to determining that the second hypervisor is not configured to supply the virtual machine metrics associated with the virtual machine, the one or more systems, the one or more methods, and/or the one or more processes may further configure hypervisor setting of the second hypervisor to supply the virtual machine metrics associated with the virtual machine.

In one or more embodiments, the one or more systems, the one or more methods, and/or the one or more processes may further determine that the second hypervisor is not capable of determining power consumption data associated with the virtual machine. For example, in response to determining that the second hypervisor is not capable of determining the power consumption data associated with the virtual machine, the one or more systems, the one or more methods, and/or the one or more processes may further install an agent on the second hypervisor to collect the power consumption data associated with the virtual machine. In one or more embodiments, the first physical information handling system and the second physical information handling system may be communicatively coupled to a network. For example, migrating, by the management console, the virtual machine from the first hypervisor to the second hypervisor on the second physical information handling system may include causing the first physical information handling system to migrate the virtual machine to the second physical information handling system via the network.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2 illustrates an example of a baseboard management controller, according to one or more embodiments;

FIG. 3 illustrates an example of a process architectures, according to one or more embodiments;

FIG. 4A illustrates an example of a method of migrating a virtual machine, according to one or more embodiments;

FIG. 4B illustrates an example of a virtual machine executing on a first physical information handling system, according to one or more embodiments;

FIG. 4C illustrates an example of migrating a virtual machine from a first physical information handling system to a second physical information handling system, according to one or more embodiments;

FIG. 5 illustrates an example of a method of operating a management console, according to one or more embodiments;

FIG. 6A illustrates an example of a method of operating a system, according to one or more embodiments; and

FIG. 6B illustrates another example of a method of operating a system, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a virtual machine may be migrated from a first physical information handling system to a second information handling system. For example, a first hypervisor executing on the first information handling system and a second hypervisor executing on the second information handling system may migrate the virtual machine from the first physical information handling system to the second information handling system. In one or more embodiments, virtual charge back may include a practice of charging back costs of virtual information technology infrastructure to a department or a business unit after resources associated with the virtual machine have been utilized on the second information handling system. In one or more embodiments, analyzing and recording resource utilization of virtual machines may be an important feature, which may have one or more implications on billing and accounting. For example, an estimation of cost related to power consumed by the virtual machine may be determined, which may then be billed over a period of time to an entity. This method of charge back may be better and/or more realistic for both a provider and a consumer of virtual infrastructure services.

In one or more embodiments, there may be scenarios where a virtual machine is migrated to a physical information handling system that is not monitored by a management console. For example, technologies, such as vSphere vMotion and System Center Virtual Machine Manager, may be utilized for load balancing and/or disaster recovery of virtual infrastructures. For instance, a management console may lose management capability of virtual machines until a new physical information handling system and/or hypervisor is discovered by the management console. In one or more embodiments, this may be a manual step, and essential metrics of the virtual machines may be lost and may have an implication on charge back costing which may lead to business loss.

In one or more embodiments, a management console (e.g., OME-Power Manager, Power Center, etc.) may include have capability to determine power consumption related a charge back for virtual machines based on resource utilization over a period. For example, data from a baseboard management controller of a physical information handling system and a hypervisor may monitor and correlated to derive inferences. For instance, power consumption of a Nth virtual machine (VW) for a period of time T may be determined via:

$${\{ {VM}_{n} Power Consumption \}}_{T} = \frac{\begin{matrix}\{ Physical Information Handling System \\ {Total Power Consumption \}}_{T}\end{matrix}}{\begin{matrix}\{ f ( {VM}_{n} Processor Utilization ) + f ( {VM}_{n} Memory Utilization ) + \\ {f ( {VM}_{n} I / O Utilizaton \}}_{T}\end{matrix}}$$

In one or more embodiments, a baseboard management controller of a physical information handling system may determine {Physical Information Handing System Total Power Consumption}_{T}. For example, {Physical Information Handing System Total Power Consumption}_{T} may be a total power consumption of the physical information handling system for a period of time T. In one or more embodiments, f(VMₙ Processor Utilization), f(VMₙ Memory Utilization), and f(VMₙ I/O Utilization) may respectively be physical processor power of a physical processor of the physical information handling system consumed by VMₙ, physical memory power of physical memory of the physical information handling system consumed by VMₙ, and physical I/O power of physical I/O of the physical information handling system consumed by VMₙ. For example, power consumed by VMₙ for a period of time T may be {f(VMₙ Processor Utilization)+f(VMₙ Memory Utilization)+f(VMₙ I/O Utilization)}_{T}. For instance, a hypervisor that executes VMₙ may determine VMₙ Processor Utilization, VMₙ Memory Utilization, and VMₙ I/O Utilization.

In one or more embodiments, when a virtual machine is migrated to an unmonitored hypervisor, a management console may lose communication with the virtual machine. For example, when communication to the virtual machine is lost, accounting for resources utilized by the virtual machine may be lost. In one or more embodiments, server side events (SSEs) may be utilized. For example, a physical information handling system executing the hypervisor may provide one or more events to the management console when the virtual machine is migrated to the physical information handling system. For example, the hypervisor may provide the one or more events to the management console via a communications protocol, such as simple network management protocol (SNMP) (e.g., version 3), Redfish, etc. As an example, the one or more events may include information based at least on the physical information handling system executing the hypervisor and an information handling system device (e.g., a baseboard management controller of the physical information handling system) that can be discovered in the management console.

In one or more embodiments, a virtual machine creation workflow may enforce an identifier assignment to ensure a primary basis of virtual machine identification may not change through one or more migrations of a virtual machine. For example, the identifier may be or may include an universally unique identifier (UUID). For instance, the UUID may remain unchanged when a name associated with the virtual machine is changed and/or a configuration associated with the virtual machine is altered. In one or more embodiments, the identity information may be utilized by one or more monitoring applications to establish authenticity and/or uniqueness of each monitored virtual machine irrespective of a physical information handling system executing a hypervisor and/or a virtual machine.

In one or more embodiments, a management console may include centralized and/or one-to-many management application that monitors physical information handling systems and workloads running on the physical information handling systems. For example, the workloads may be hosted directly on a physical information handling system (e.g., “bare-metal”) or part of a virtualization infrastructure, such as Dell EMC OpenManage Enterprise, among others. In one or more embodiments, the management console may include a credentials manager. For example, the credentials manager may be or may include a module within the management console that stores and manages credentials for various operations securely.

In one or more embodiments, the management console may include a discovery module. For example, the discovery module may discover and may inventory managed nodes. For instance, the discovery module may utilize the credentials manager and/or may implement one or more interfaces and/or one or more protocols to identify and collect information from managed nodes (e.g., managed physical information handling systems) and/or vendors (e.g. VMware, Microsoft, etc.). In one or more embodiments, the management console may include an event module. For example, the event module may receive, may recognize, may process, may store, and/or may generate one or more types of events.

In one or more embodiments, the management console may include a hypervisor manager. For example, the hypervisor manager may manage a virtualized infrastructure. For instance, the hypervisor manager may manage a virtualized infrastructure such as vCenter for VMware ESXi or Microsoft System Centre Virtual Machine Manager (SCVMM) for Microsoft Hyper-V, among others.

In one or more embodiments, a virtual machine may include an isolated computing environment created by abstracting resources from a physical information handling system. In one or more embodiments, a management module may include a baseboard management controller of a physical information handling system. In one or more embodiments, a vendor software agent may include software installed on an operating system to establish secure communication and information exchange between an operating system and a baseboard management controller.

In one or more embodiments, during a creation of a virtual machine, a UUID may be assigned to the virtual machine, which may not change across a migration of the virtual machine from a first hypervisor to a second hypervisor, different from the first hypervisor. For example, a policy may be defined on managed hypervisors that includes criteria for an optimum virtual ecosystem management. When a user (e.g., an administrator) manually triggers a virtual machine migration, the policy may be evaluated with respect to a target hypervisor (e.g., the second hypervisor) and may provide feedback if conditions are not met. For example, the user may reconfigure settings on the target hypervisor or select another target hypervisor (e.g., a third hypervisor, different from the first hypervisor and different from the second hypervisor). This may be utilized in an automated migration scenario as well by including a default choice in the policy.

In one or more embodiments, when a virtual machine is migrated from a source hypervisor (e.g., a first hypervisor) to a destination hypervisor (e.g., a second hypervisor, different from the first hypervisor), the hypervisor manager may send an event to the management console. For example, the hypervisor manager may send an event to the management console via a secure communications protocol. For instance, the event may include information, such as an Internet protocol (IP) address of the source hypervisor, an IP address of the destination hypervisor, and/or a destination hypervisor vendor, among others.

In one or more embodiments, the event manager of the management console may receive the event for post processing. In one or more embodiments, the event manager may interface with the discover module of the management console to initiate discovery of the IP address of the destination hypervisor and may provide supporting protocol information and/or vendor information.

In one or more embodiments, the discovery module may determine an applicable protocol for discovery based at least on vendor to protocol mapping metadata. In one or more embodiments, the discovery module may interface with the credentials module of the management console to determine applicable credentials for a vendor specific discovery protocol. For example, the discovery module may determine if the vendor specific discovery protocol utilizes an IP address.

In one or more embodiments, if the vendor specific discovery protocol utilizes an IP address, the discovery module may refresh an inventory of previously discovered hypervisors. For example, as a result, the management console may identify a virtual machine migration and may continue to monitor the virtual machine migration and/or a virtual machine associated with the virtual machine migration. In one or more embodiments, if the vendor specific discovery protocol does not utilize an IP address, the discovery module may initiate a new discovery process utilizing applicable credentials and a vendor specific protocol. In one example, after discovery completes and the hypervisor is on boarded, the management console may identify the virtual machine and may continue to monitor the virtual machine. In another example, a baseboard management controller of a destination physical information handling system associated with the destination hypervisor may be on boarded.

In one or more embodiments, the management console may utilize a UUID associated with the virtual machine to establish the virtual machine as an existing monitored virtual machine and not a new virtual machine, such that historical data may be correlated. In one or more embodiments, the management console may update an association of the virtual machine from the source hypervisor to the destination hypervisor to reflect actual hosting scheme.

In one or more embodiments, the management console may monitor multiple virtual machines, which may be executing via multiple hypervisors. For example, the multiple hypervisors may be executing on respective multiple physical information handling systems. In one or more embodiments, the management console may interface with a first hypervisor of the multiple hypervisors. For example, the management console may determine a first power consumption of a virtual machine of the multiple virtual machines that is executing via the first hypervisor. For instance, the management console may determine a charge back based at least on the first power consumption of the virtual machine that is executing via the first hypervisor.

In one or more embodiments, the virtual machine may begin migrating from the first hypervisor (e.g., a source hypervisor) to a second hypervisor (e.g., a destination hypervisor) of the multiple hypervisors. For example, the first hypervisor may begin migrating the virtual machine to the second hypervisor. In one or more embodiments, the virtual machine may execute via the second hypervisor after the virtual machine is migrated from the first hypervisor to the second hypervisor. In one or more embodiments, the first hypervisor may generate an event (e.g., a server side event) for the management console with information associated with migrating the virtual machine from the first hypervisor to the second hypervisor. For example, the first hypervisor may provide the event, which may include the information associated with migrating the virtual machine from the first hypervisor to the second hypervisor, to the management console.

In one or more embodiments, the management console may process the event. For example, processing the event may include determining if the management console has discovered the second hypervisor. If the management console has discovered the second hypervisor, the management console may refresh an inventory associated with the first hypervisor and/or may detect the virtual machine executing via the second hypervisor. For example, refreshing the inventory associated with the first hypervisor may include removing the virtual machine, which was migrated from the first hypervisor to the second hypervisor, from the inventory associated with the first hypervisor.

If the management console has not discovered the second hypervisor, the management console may discover the second hypervisor and/or may detect the virtual machine executing via the second hypervisor. In one or more embodiments, the management console may refresh an inventory associated with the second hypervisor. For example, refreshing the inventory associated with the second hypervisor may include adding the virtual machine, which was migrated from the first hypervisor to the second hypervisor, from the inventory associated with the second hypervisor. In one or more embodiments, the management console may determine a second power consumption of the virtual machine that is executing via the second hypervisor. For instance, the management console may determine a charge back based at least on the second power consumption of the virtual machine that is executing via the second hypervisor.

In one or more embodiments, the management console may determine if a hypervisor is configured to supply virtual machine metrics. If the hypervisor is not configured to supply virtual machine metrics, the management console may configure the hypervisor setting during an on boarding of the hypervisor. If the hypervisor is configured to supply virtual machine metrics, the management console may determine if a baseboard management controller of a physical information handling system, which is executing the hypervisor, is capable of determining power consumption data of the physical information handling system. If the baseboard management controller of the physical information handling system is not capable of determining power consumption data of the physical information handling system, the management console may install a vendor agent during hypervisor on boarding and utilize the vendor agent to collect power consumption data. In one example, the vendor agent to collect power consumption data associated with a virtual machine. In another example, the vendor agent to collect power consumption data associated with the physical information handling system.

If the baseboard management controller of the physical information handling system is capable of determining power consumption data of the physical information handling system, the management console may determine if the baseboard management controller is configured to supply power the consumption data of the physical information handling system. If the baseboard management controller is not configured to supply power the consumption data of the physical information handling system, the management console may configure required baseboard management controller settings during on boarding.

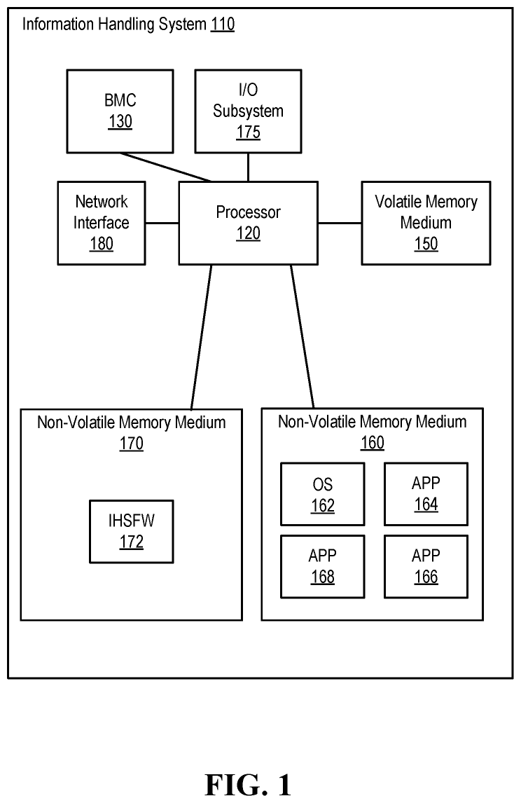

Turning now to FIG. 1, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a baseboard management controller (BMC) 130, a volatile memory medium 150, non-volatile memory media 160 and 170, an I/O subsystem 175, and a network interface 180. As illustrated, BMC 130, volatile memory medium 150, non-volatile memory media 160 and 170, I/O subsystem 175, and network interface 180 may be communicatively coupled to processor 120.

In one or more embodiments, one or more of BMC 130, volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of BMC 130, volatile memory medium 150, non-volatile memory media 160 and 170, I/O subsystem 175, and network interface 180 may be communicatively coupled to processor 120 via one or more PCI-Express (PCIe) root complexes. In another example, one or more of I/O BMC 130, I/O subsystem 175, and network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network. In one instance, the wireless network may include a cellular telephone network. In a second instance, the wireless network may include a satellite telephone network. In another instance, the wireless network may include a wireless Ethernet network (e.g., a Wi-Fi network, an IEEE 802.11 network, etc.).

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (i SC SI), or any combination thereof, among others.

In one or more embodiments, processor 120 may execute processor instructions in implementing at least a portion of one or more systems, at least a portion of one or more flowcharts, at least a portion of one or more methods, and/or at least a portion of one or more processes described herein. In one example, processor 120 may execute processor instructions from one or more of memory media 150, 160, and 170 in implementing at least a portion of one or more systems, at least a portion of one or more flowcharts, at least a portion of one or more methods, and/or at least a portion of one or more processes described herein. In another example, processor 120 may execute processor instructions via network interface 180 in implementing at least a portion of one or more systems, at least a portion of one or more flowcharts, at least a portion of one or more methods, and/or at least a portion of one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150, 160, and 170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, OS 162 may include a management information exchange. In one example, the management information exchange may permit multiple components to exchange management information associated with managed elements and/or may permit control and/or management of the managed elements. In another example, the management information exchange may include a driver and/or a driver model that may provide an OS interface through which managed elements (e.g., elements of IHS 110) may provide information and/or notifications, among others. In one instance, the management information exchange may be or include a Windows Management Interface (WMI) for ACPI (available from Microsoft Corporation). In another instance, the management information exchange may be or include a Common Information Model (CIM) (available via the Distributed Management Task Force). In one or more embodiments, the management information exchange may include a combination of the WMI and the CIM. For example, WMI may be and/or may be utilized as an interface to the CIM. For instance, the WMI may be utilized to provide and/or send CIM object information to OS 162.

In one or more embodiments, processor 120 and one or more components of IHS 110 may be included in a system-on-chip (SoC). For example, the SoC may include processor 120 and a platform controller hub (not specifically illustrated).

In one or more embodiments, BMC 130 may be or include a remote access controller. For example, the remote access controller may be or include a DELL™ Remote Access Controller (DRAC). In one or more embodiments, a remote access controller may be integrated into IHS 110. For example, the remote access controller may be or include an integrated DELL™ Remote Access Controller (iDRAC). In one or more embodiments, a remote access controller may include one or more of a processor, a memory, and a network interface, among others. In one or more embodiments, a remote access controller may access one or more busses and/or one or more portions of IHS 110. For example, the remote access controller may include and/or may provide power management, virtual media access, and/or remote console capabilities, among others, which may be available via a web browser and/or a command line interface. For instance, the remote access controller may provide and/or permit an administrator (e.g., a user) one or more abilities to configure and/or maintain an information handling system as if the administrator was at a console of the information handling system and/or had physical access to the information handling system.

In one or more embodiments, a remote access controller may interface with baseboard management controller integrated circuits. In one example, the remote access controller may be based at least on an Intelligent Platform Management Interface (IPMI) standard. For instance, the remote access controller may allow and/or permit utilization of IPMI out-of-band interfaces such as IPMI Over LAN (local area network). In another example, the remote access controller may be based at least on a Redfish standard. In one instance, one or more portions of the remote access controller may be compliant with one or more portions of a Redfish standard. In another instance, one or more portions of the remote access controller may implement one or more portions of a Redfish standard. In one or more embodiments, a remote access controller may include and/or provide one or more internal private networks. For example, the remote access controller may include and/or provide one or more of an Ethernet interface, a front panel USB interface, and a Wi-Fi interface, among others. In one or more embodiments, a remote access controller may be, include, or form at least a portion of a virtual KVM (keyboard, video, and mouse) device. For example, a remote access controller may be, include, or form at least a portion of a KVM over IP (IPKVM) device. For instance, a remote access controller may capture video, keyboard, and/or mouse signals; may convert the signals into packets; and may provide the packets to a remote console application via a network.

In one or more embodiments, BMC 130 may be or include a microcontroller. For example, the microcontroller may be or include an 8051 microcontroller, an ARM Cortex-M (e.g., Cortex-M0, Cortex-M1, Cortex-M3, Cortex-M4, Cortex-M7, etc.) microcontroller, a MSP430 microcontroller, an AVR (e.g., 8-bit AVR, AVR-32, etc.) microcontroller, a PIC microcontroller, a 68HC11 microcontroller, a ColdFire microcontroller, and a Renesas microcontroller, among others. In one or more embodiments, BMC 130 may be or include an application processor. In one example, BMC 130 may be or include an ARM Cortex-A processor. In another example, BMC 130 may be or include an Intel Atom processor. In one or more embodiments, BMC 130 may be or include one or more of a field programmable gate array (FPGA) and an ASIC, among others, configured, coded, and/or encoded with instructions in accordance with at least a portion of one or more of systems, at least a portion of one or more flowcharts, at least a portion of one or more methods, and/or at least a portion of one or more processes described herein.

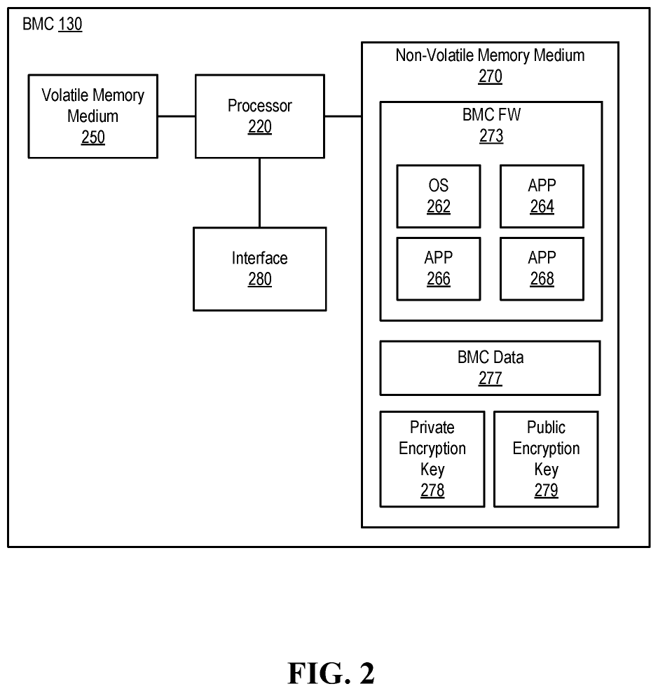

Turning now to FIG. 2, an example of a baseboard management controller is illustrated, according to one or more embodiments. As shown, BMC 130 may include a processor 220, a volatile memory medium 250, a non-volatile memory medium 270, and an interface 280. As illustrated, non-volatile memory medium 270 may include a BMC firmware (FW) 273, which may include an OS 262 and APPs 264-268, and may include BMC data 277. In one example, OS 262 may be or include a real-time operating system (RTOS). For instance, the RTOS may be or include FreeRTOS, OpenRTOS, SafeRTOS, QNX, ThreadX, VxWorks, NuttX, TI-RTOS, eCos, MicroC/OS, or Zephyr, among others. In a second example, OS 262 may be or include an Unix-like operating system. For instance, the Unix-like operating system may be or include LINUX®, FREEBSD®, NETBSD®, OpenBSD, Minix, Xinu, or Darwin, among others. In another example, OS 262 may be or include a portable operating system interface (POSIX) compliant operating system. As illustrated, non-volatile memory medium 270 may include a private encryption key 278. As shown, non-volatile memory medium 270 may include a public encryption key 279. In one or more embodiments, private encryption key 278 may be different from public encryption key 279. For example, private encryption key 278 and public encryption key 279 may be asymmetric encryption keys. In one instance, data encrypted via private encryption key 278 may be decrypted via public encryption key 279. In another instance, data encrypted via public encryption key 279 may be decrypted via private encryption key 278.

In one or more embodiments, interface 280 may include circuitry that enables communicatively coupling to one or more devices. In one example, interface 280 may include circuitry that enables communicatively coupling to one or more buses. For instance, the one or more buses may include one or more buses described herein, among others. In a second example, interface 280 may include circuitry that enables one or more interrupt signals to be received. In one instance, interface 280 may include general purpose input/output (GPIO) circuitry, and the GPIO circuitry may enable one or more interrupt signals to be received and/or provided via at least one interrupt line. In another instance, interface 280 may include GPIO circuitry that may enable BMC 130 to provide and/or receive signals associated with other circuitry (e.g., diagnostic circuitry, etc.). In a third example, interface 280 may include circuitry that enables communicatively coupling to one or more networks. In one instance, interface 280 may include circuitry that enables communicatively coupling to network interface 180. In another example, interface 280 may include a network interface. For instance, interface 280 may include an USB network interface (NIC).

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250. In one or more embodiments, processor 220 may execute instructions in accordance with at least a portion of one or more systems, at least a portion of one or more flowcharts, one or more methods, and/or at least a portion of one or more processes described herein. For example, non-volatile memory medium 270 and/or volatile memory medium 250 may store instructions that may be executable in accordance with at least a portion of one or more systems, at least a portion of one or more flowcharts, at least a portion of one or more methods, and/or at least a portion of one or more processes described herein. In one or more embodiments, processor 220 may execute instructions in accordance with at least a portion of one or more of systems, flowcharts, at least a portion of one or more methods, and/or at least a portion of one or more processes described herein. For example, non-volatile memory medium 270 and/or volatile memory medium 250 may store instructions that may be executable in accordance with at least a portion of one or more of systems, at least a portion of one or more flowcharts, at least a portion of one or more methods, and/or at least a portion of one or more processes described herein. In one or more embodiments, processor 220 may utilize BMC data 277. In one example, processor 220 may utilize BMC data 277 via non-volatile memory medium 270. In another example, one or more portions of BMC data 277 may be transferred to volatile memory medium 250, and processor 220 may utilize BMC data 277 via volatile memory medium 250.

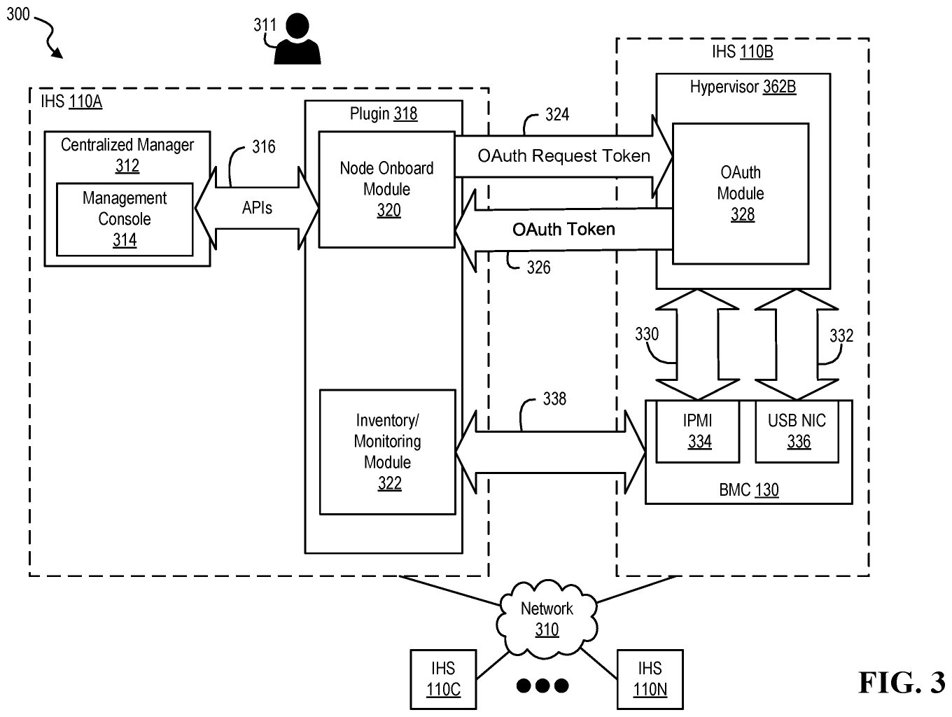

Turning now to FIG. 3, an example of a process architectures is illustrated, according to one or more embodiments. In one or more embodiments, a system 300 may include multiple physical information handling systems. For example, system 300 may include physical information handling systems (IHSs) 110A-110N. For instance, IHSs 110A-110N may be coupled to a network 310. In one or more embodiments, system 300 may include network 310. In one or more embodiments, system 300 may include a virtual infrastructure. For example, the virtual infrastructure may include IHSs 110B-110N. For instance, IHSs 110B-110N may be physical nodes (e.g., physical information handling system nodes) of the virtual infrastructure. As an example, the physical nodes of the virtual infrastructure may execute guest operating systems via respective hypervisors. In one or more embodiments, a physical node of the virtual infrastructure may a hypervisor, which may execute guest one or more guest operating systems. For example, a virtual machine may execute a guest operating system. Although FIG. 3 is illustrated with IHSs 110B-110N, a virtual infrastructure may include any number of IHSs 110 as physical nodes of the virtual infrastructure, according to one or more embodiments. Although not specifically illustrated, a network interface 182 of an IHS 110 may be coupled to network 310, for example. In one or more embodiments, BMC 130 may be coupled to network 310. For example, BMC 130 may be coupled to network 310 via interface 280.

In one or more embodiments, network 310 may include a wired network, a wireless network, an optical network, or a combination of the foregoing, among others. For example, network 310 may include and/or be coupled to various types of communications networks. For instance, network 310 may include and/or be coupled to a LAN, a WAN (e.g., a private WAN, a corporate WAN, a public WAN, etc.), an Internet, a public switched telephone network (PSTN), a cellular telephone network, a satellite telephone network, or a combination of the foregoing, among others.

In one or more embodiments, a user (e.g., an administrator) 311 may utilize IHS 110A. For example, IHS 110A may be an administrator information handling system. In one or more embodiments, IHS 110A may include a centralized manager 312. For example, centralized manager 312 may be or may include vCenter, available from VMware, Inc. For instance, centralized manager 312 may provide centralized management of a virtual infrastructure. As an example, user 311 may utilize centralized manager 312 to manage a virtual infrastructure. In one or more embodiments, centralized manager 312 may include instructions executable by a processor 120 of IHS 110A. In one or more embodiments, centralized manager 312 may include a management console 314. For example, management console 314 may manage hardware of an IHS 110. For instance, user 311 may utilize management console 314 to manage hardware of IHSS 110B-110N, among others. In one or more embodiments, management console 314 may include instructions executable by a processor 120 of IHS 110A.

In one or more embodiments, IHS 110A may include a plugin 318. For example, plugin 318 may interface with hardware of IHSs 110B-110N. For instance, plugin 318 may interface with original equipment manufacturer (OEM) hardware of IHSs 110B-110N. As an example, the OEM may be DELL™. In one or more embodiments, plugin 318 may include instructions executable by a processor 120 of IHS 110A. For example, management console 314 may utilize plugin 318 to interface with hardware of IHSs 110B-110N. For instance, management console 314 may utilize application programming interfaces (APIs) 316 interface with plugin 318. In one or more embodiments, plugin 318 may include a node onboard module 320. For example, node onboard module 320 may include instructions executable by a processor 120 of IHS 110A.

In one or more embodiments, IHS 110B may include a hypervisor 362B. For example, hypervisor 362B may be or may include a “bare metal” hypervisor. For instance, hypervisor 362B may be or may include an ESXi hypervisor, available from VMware, Inc. In one or more embodiments, hypervisor 362B may include an OAuth module 328. For example, OAuth module 328 may include instructions executable by a processor 120 of IHS 110B. For instance, OAuth module 328 may be or may include a plugin to hypervisor 362B. As an example, OAuth module 328 may be or may include an agent, which may include instructions executable by a processor 120 of IHS 110B, that may provide communications between BMC 130 of IHS 110B and one or more of node onboard module 320, plugin 318, management console 314, centralized manager 312, and IHS 110A, among others. In one or more embodiments, OAuth module 328 may communicate via a secure communications protocol. For example, a secure communications protocol may be implemented via one or more of a transport layer security (TLS), a hypertext transfer protocol secure (HTTPS), and a secure socket layer (SSL), among others.

In one or more embodiments, BMC 130 may include an IPMI 334. For example, hypervisor 362B may provide and/or may receive communications 330 to and/or from BMC 130 via IPMI 334. For instance, communications 330 may be secured via a secure communications protocol. In one or more embodiments, BMC 130 may include an USB NIC 336. In one example, hypervisor 362B may provide communications 332 to BMC 130 via USB NIC 336. In another example, hypervisor 362B may receive communications 332 from BMC 130 via USB NIC 336. In one or more embodiments, communications 332 may be secured via a secure communications protocol. In one or more embodiments, hypervisor 362B may interface with an USB of IHS 110B. For example, hypervisor 362B may be communicatively coupled to BMC 130 via the USB. For instance, hypervisor 362B may be communicatively coupled to BMC 130 via USB NIC 336.

In one or more embodiments, plugin 318 may include an inventory/monitoring module 322. In one example, inventory/monitoring module 322 may provide communications 338 to BMC 130. For instance, module 322 may provide communications 338 to BMC 130 via network 310. In another example, inventory/monitoring module 322 may receive communications 338 from BMC 130. For instance, module 322 may receive communications 338 from BMC 130 via network 310. In one or more embodiments, BMC 130 may provide, to inventory/monitoring module 322 via communications 338, information that indicates that a virtual machine (VM) has been added to IHS 110B. In one or more embodiments, BMC 130 may provide, to inventory/monitoring module 322 via communications 338, information that indicates a power consumption of IHS 110B. For example, BMC 130 may provide, to inventory/monitoring module 322 via communications 338, information that indicates a total power consumption of IHS 110B.

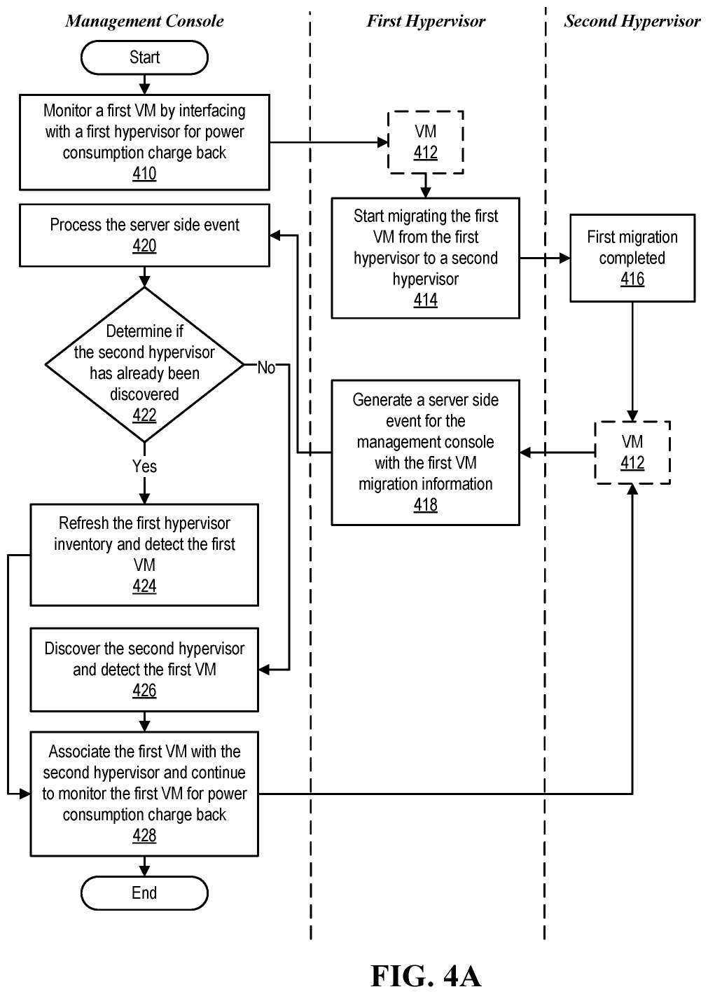

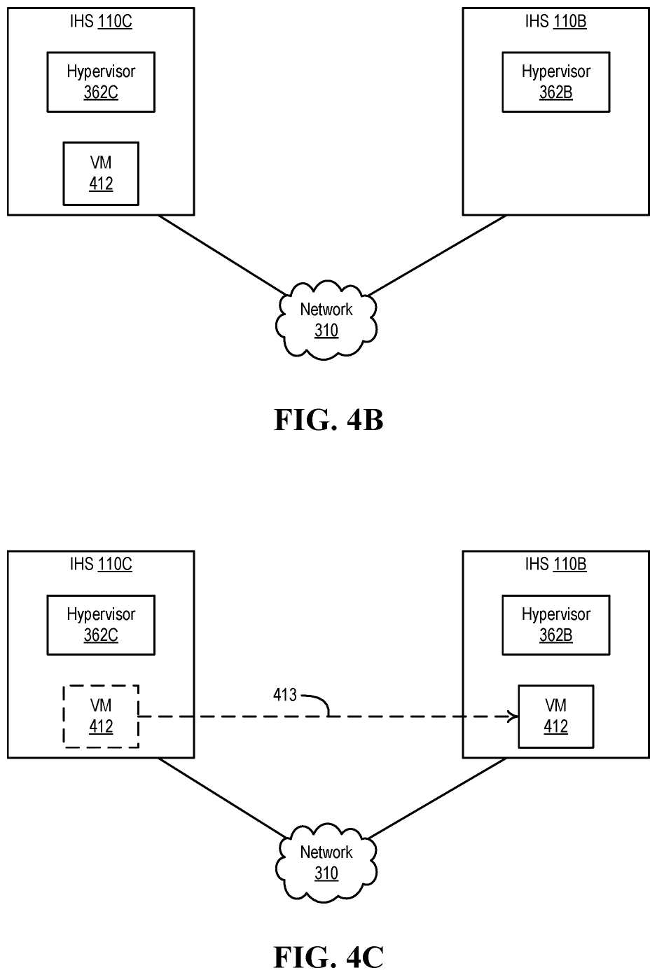

Turning now to FIG. 4A, an example of a method of migrating a virtual machine is illustrated, according to one or more embodiments. At 410, a first VM may be monitored by interfacing with a first hypervisor for power consumption charge back. For example, the first hypervisor (e.g., hypervisor 362C illustrated in FIG. 4B) may monitor the first VM (e.g., VM 412 shown in FIG. 4B) for the power consumption charge back. For instance, the first VM, by interfacing with the first hypervisor, may be monitored for the power consumption charge back.

At 414, a migration of the first VM from the first hypervisor to a second hypervisor may be started. In one example, management console 314 may start migrating VM 412 from the first hypervisor (e.g., a hypervisor 362C illustrated in FIG. 4B) to the second hypervisor (e.g., hypervisor 362B shown in FIG. 4B). In another example, the first hypervisor (e.g., hypervisor 362C) may start migrating VM 412 from the first hypervisor to the second hypervisor (e.g., hypervisor 362B). In one or more embodiments, hypervisor 362C may include one or more structures and/or one or more functionalities of those described with reference to hypervisor 362B. In one or more embodiments, IHSs 110D-110N may respectively include hypervisors that may include one or more structures and/or one or more functionalities of those described with reference to hypervisor 362B.

At 416, a first migration may be completed. For example, a first migration (e.g., migration 413) of VM 412 may be completed, as shown in FIG. 4C. For instance, the first migration of VM 412 may include migrating VM 412 from the first hypervisor (e.g., hypervisor 362C) to the second hypervisor (e.g., hypervisor 362B). In one or more embodiments, migration 413 may occur via network 310. For example, VM 412 may be migrated from IHS 110C to IHS 110B via network 310. For instance, VM 412 may be migrated from hypervisor 362C to hypervisor 362B via network 310.

At 418, a server side event may be generated for the management console with the first virtual machine migration information. For example, the first hypervisor may generate a server side event for the management console with the first virtual machine migration information. For instance, hypervisor 362C may generate a server side event for management console 314 with the first virtual machine migration information. At 420, the server side event may be processed. For example, management console 314 may process the server side event.

At 422, it may be determined if the second hypervisor has already been discovered. For example, management console 314 may determine if the second hypervisor (e.g., hypervisor 362B) has already been discovered. If the second hypervisor has already been discovered, the first hypervisor inventory may be refreshed and the first virtual machine may be detected, at 424. In one or more embodiments, the method may proceed to 428. If the second hypervisor has not already been discovered, the second hypervisor (e.g., hypervisor 362B) may be discovered and the first virtual machine (e.g., VM 412) may be detected, at 426.

At 428, the first virtual machine (e.g., VM 412) may be associated with the second hypervisor (e.g., hypervisor 362B) and the first virtual machine may be continued to be monitored for power consumption charge back. For example, management console 314 may associate VM 412 with the second hypervisor (e.g., hypervisor 362B) and may continue to monitor VM 412 for power consumption charge back.

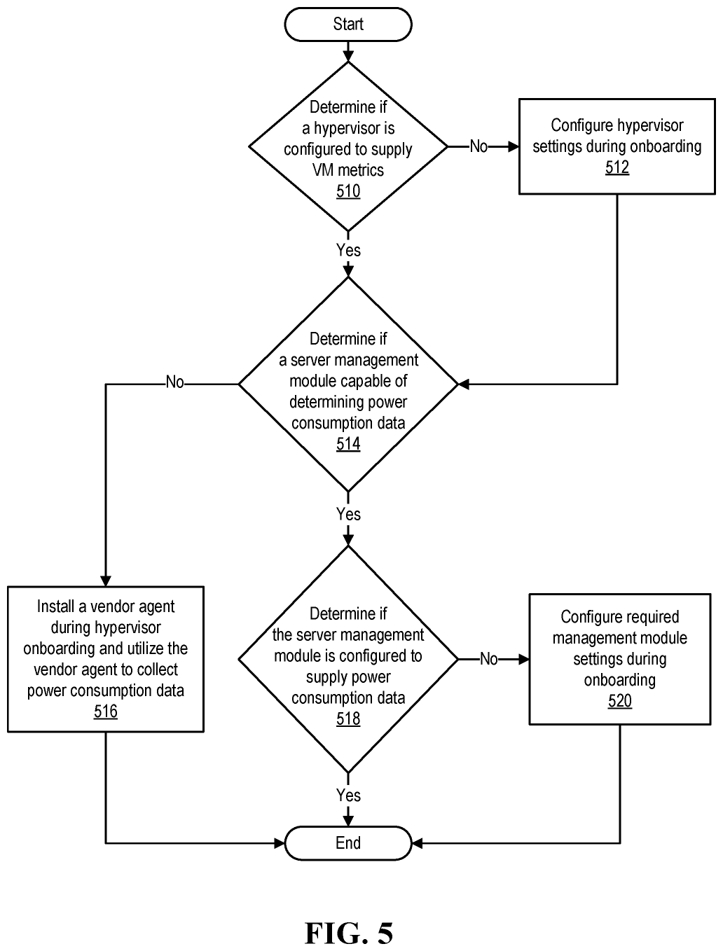

Turning now to FIG. 5, an example of a method of operating a management console is illustrated, according to one or more embodiments. At 510, it may be determined if a hypervisor is configured to supply virtual machine metrics. For example, management console 314 may determine if a hypervisor is configured to supply virtual machine metrics. If the hypervisor is not configured to supply the virtual machine metrics, hypervisor settings may be configured during onboarding, at 512. For example, management console 314 may configure hypervisor settings associated with the hypervisor. If the hypervisor is configured to supply the virtual machine metrics, it may be determined if a server management module is capable of determining power consumption data, at 514. For example, management console 314 may determine if a server management module is capable of determining power consumption data.

If the server management module is not capable of determining power consumption data, a vendor agent may be installed agent during hypervisor onboarding, and the vendor agent may be utilized to collect power consumption data, at 516. For example, management console 314 may install a vendor agent during hypervisor onboarding and may utilize the vendor agent to collect power consumption data. In one or more embodiments, the method may conclude subsequent to 516. If the server management module is capable of determining power consumption data, it may be determined if the server management module is configured to supply power consumption data, at 518. For example, management console 314 may determine if the server management module is configured to supply power consumption data. If the server management module is not configured to supply power consumption data, required management module settings may be configured during onboarding, at 520. For example, management console 314 may configure required management module settings during onboarding. In one or more embodiments, the method may conclude subsequent to 520. If the server management module is configured to supply power consumption data, the method may conclude, according to one or more embodiments.

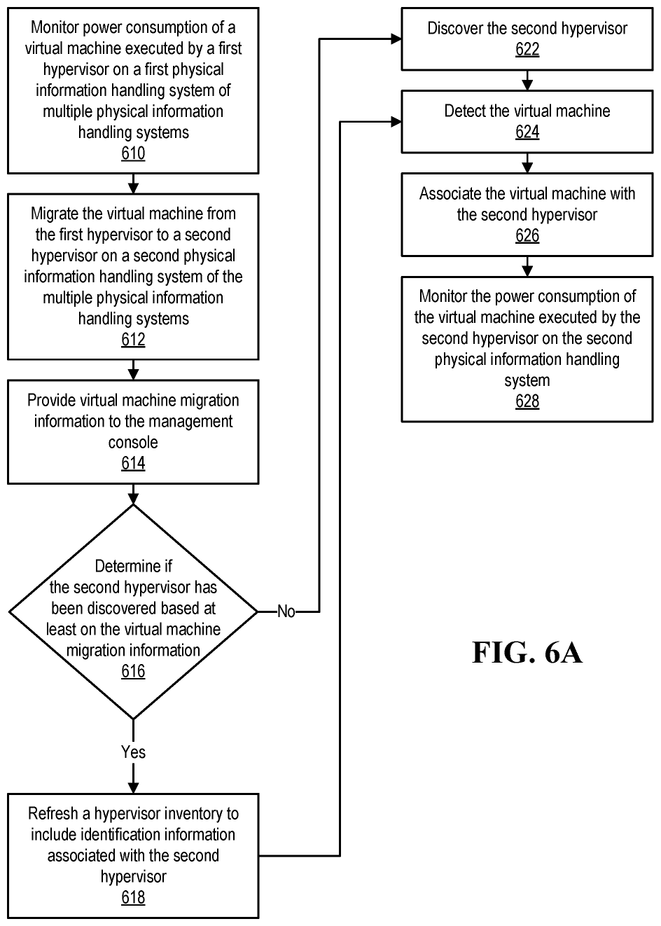

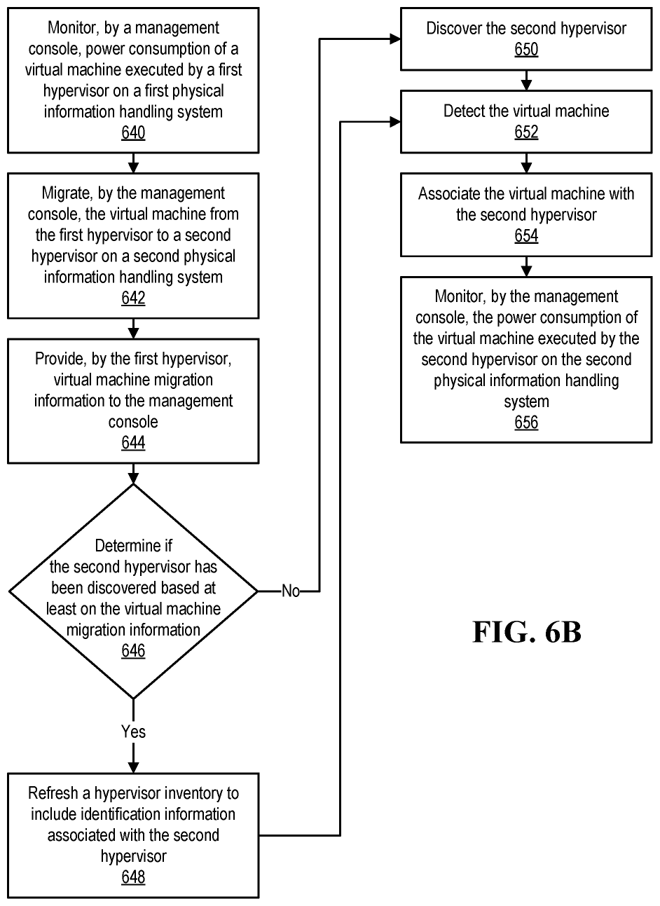

Turning now to FIG. 6A, an example of a method of operating a system is illustrated, according to one or more embodiments. At 610, power consumption of a virtual machine executed by a first hypervisor on a first physical information handling system of multiple physical information handling systems may be monitored. For example, an administrator physical information handling system (e.g., IHS 110A) of the multiple physical information handling systems (e.g., IHSs 110A-110N) may be configured with a management console (e.g., management console 314) that may be configured to monitor power consumption of a virtual machine (e.g., VM 412) executed by a first hypervisor (e.g., hypervisor 362C) on a first physical information handling system (e.g., IHS 110C) of the multiple physical information handling systems.

At 612, the virtual machine may be migrated from the first hypervisor to a second hypervisor on a second physical information handling system of the multiple physical information handling systems. For example, the management console (e.g., management console 314) may be further configured to migrate the virtual machine from the first hypervisor to a second hypervisor (e.g., hypervisor 362B) on a second physical information handling system (e.g., IHS 110B) of the multiple physical information handling systems. At 614, virtual machine migration information may be provided to the management console. For example, the first hypervisor may be configured to provide virtual machine migration information to the management console.

At 616, it may be determined if the second hypervisor has been discovered based at least on the virtual machine migration information. For example, the management console may be further configured to determine if the second hypervisor has been discovered based at least on the virtual machine migration information. If the second hypervisor has been discovered based at least on the virtual machine migration information, a hypervisor inventory may be refreshed to include identification information associated with the second hypervisor, at 618. For example, the management console may be further configured to refresh a hypervisor inventory to include identification information associated with the second hypervisor if the second hypervisor has been discovered based at least on the virtual machine migration information. In one or more embodiments, the method may proceed to 624. If the second hypervisor has not been discovered based at least on the virtual machine migration information, the second hypervisor may be discovered, at 622. For example, the management console may be further configured to discover the second hypervisor if the second hypervisor has not been discovered based at least on the virtual machine migration information.

At 624, the virtual machine may be detected. For example, the management console may be further configured to detect the virtual machine. For instance, the management console may be further configured to detect the virtual machine executing on the second physical information handling system. At 626, the virtual machine may be associated with the second hypervisor. For example, the management console may be further configured to associate the virtual machine with the second hypervisor. In one or more embodiments, associating the virtual machine with the second hypervisor may include associating the virtual machine with the second hypervisor in the hypervisor inventory. For example, associating the virtual machine with the second hypervisor may include associating the virtual machine with the identification information associated with the second hypervisor in the hypervisor inventory. For instance, the identification information associated with the second hypervisor may be or may include a UUID.

At 628, the power consumption of the virtual machine executed by the second hypervisor on the second physical information handling system may be monitored. For example, the management console may be further configured to monitor the power consumption of the virtual machine executed by the second hypervisor on the second physical information handling system. In one or more embodiments, the second physical information handling system includes a baseboard management controller. For example, the management console monitoring the power consumption of the virtual machine executed by the second hypervisor may include the receiving, from the baseboard management controller, power consumption information of the second physical information handling system. For instance, the management console may be further configured to receive, from the baseboard management controller, power consumption information of the second physical information handling system.

In one or more embodiments, the management console monitoring the power consumption of the virtual machine executed by the second hypervisor may include the management console determining the power consumption of the virtual machine executed by the second hypervisor based at least on the power consumption information of the second physical information handling system. For example, the management console may be further configured to determine the power consumption of the virtual machine executed by the second hypervisor based at least on the power consumption information of the second physical information handling system. In one or more embodiments, the management console determining the power consumption of the virtual machine executed by the second hypervisor based at least on the power consumption information of the second physical information handling system may include the management determining the power consumption of the virtual machine executed by the second hypervisor based at least on a first portion of power of a physical processor of the second physical information handling system utilized by the virtual machine and a second portion of power of physical memory of the second physical information handling system utilized by the virtual machine. For example, the management console may be further configured to determine the power consumption of the virtual machine executed by the second hypervisor based at least on a first portion of power of a physical processor of the second physical information handling system utilized by the virtual machine and a second portion of power of physical memory of the second physical information handling system utilized by the virtual machine.

Turning now to FIG. 6B, another example of a method of operating a system is illustrated, according to one or more embodiments. At 640, a management console may monitor power consumption of a virtual machine executed by a first hypervisor on a first physical information handling system. For example, management console 314 may monitor power consumption of VM 412 executed by hypervisor 362C on IHS 110C. At 642, the management console may migrate the virtual machine from the first hypervisor to a second hypervisor on a second physical information handling system. For example, management console 314 may migrate VM 412 from hypervisor 362C on IHS 110C to hypervisor 362B on IHS 110B.

At 644, the first hypervisor may provide virtual machine migration information to the management console. For example, hypervisor 362C may provide virtual machine migration information to management console 314. For instance, hypervisor 362C may provide virtual machine migration information to management console 314 in response to management console 314 migrating VM 412 from hypervisor 362C on IHS 110C to hypervisor 362B on IHS 110B. At 646, the management console may determine if the second hypervisor has been discovered based at least on the virtual machine migration information. For example, management console 314 may determine if hypervisor 362B has been discovered based at least on the virtual machine migration information. If the second hypervisor has been discovered based at least on the virtual machine migration information, a hypervisor inventory may be refreshed to include identification information associated with the second hypervisor, at 648. For example, management console 314 may refresh a hypervisor inventory to include identification information associated with hypervisor 362B. For instance, IHS 110A may store the hypervisor inventory. In one or more embodiments, the method may proceed to 652. If the second hypervisor has not been discovered, the second hypervisor may be discovered, at 650. For example, management console 314 may discover hypervisor 362B. For instance, management console 314 may discover hypervisor 362B executing on IHS 110B.

At 652, the virtual machine may be detected. For example, management console 314 may detect VM 412. In one instance, management console 314 may detect VM 412 executing via hypervisor 362B. In another instance, management console 314 may detect VM 412 executing on IHS 110B. At 654, the virtual machine may be associated with the second hypervisor. For example, management console 314 may associate VM 412 with hypervisor 362B. In one or more embodiments, associating the virtual machine with the second hypervisor may include associating the virtual machine with the second hypervisor in the hypervisor inventory. For example, associating the virtual machine with the second hypervisor may include associating the virtual machine with the identification information associated with the second hypervisor in the hypervisor inventory. For instance, an identification (e.g., a UUID) may be associated with the virtual machine, which may be associated with the identification information associated with the second hypervisor in the hypervisor inventory. At 656, the management console may monitor the power consumption of the virtual machine executed by the second hypervisor on the second physical information handling system. For example, management console 314 may monitor the power consumption of VM 412 executed by hypervisor 362B on IHS 110B.

In one or more embodiments, monitoring the power consumption of the virtual machine executed by the second hypervisor may include receiving, from a baseboard management controller of the second physical information handling system, power consumption information of the second physical information handling system. In one example, monitoring the power consumption of the virtual machine executed by the second hypervisor may include determining the power consumption of the virtual machine executed by the second hypervisor based at least on the power consumption information of the second physical information handling system. For instance, determining the power consumption of the virtual machine executed by the second hypervisor based at least on the power consumption information of the second physical information handling system may include determining the power consumption of the virtual machine executed by the second hypervisor based at least on a first portion of power of a physical processor of the second physical information handling system (e.g., a processor 120 of IHS 110B) utilized by the virtual machine and a second portion of power of physical memory of the second physical information handling system (e.g., a volatile memory medium 150 of IHS 110B) utilized by the virtual machine. In another example, the baseboard management controller may determine the power consumption information of the second physical information handling system. For instance, the baseboard management controller may be communicatively coupled to multiple busses of the second physical information handling system. As an example, determining the power consumption information of the second physical information handling system may include: the baseboard management controller receiving information from at least one of the multiple busses; and the baseboard management controller determining the power consumption information of the second physical information handling system based at least on the information from the at least one of the multiple busses.

In one or more embodiments, one or more of the method and/or process elements and/or one or more portions of a method and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with at least a portion of one or more flowcharts, at least a portion of one or more systems, at least a portion of one or more methods, and/or at least a portion of one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system, comprising:
a plurality of physical information handling systems coupled to a network;
wherein an administrator physical information handling system of the plurality of physical information handling systems is configured with a management console, which is configured to:
monitor power consumption of a virtual machine executed by a first hypervisor on a first physical information handling system of the plurality of physical information handling systems; and
migrate the virtual machine from the first hypervisor to a second hypervisor on a second physical information handling system of the plurality of physical information handling systems;
wherein the first hypervisor is configured to provide virtual machine migration information to the management console; and
wherein the management console is further configured to:
determine if the second hypervisor has been discovered based at least on the virtual machine migration information;
if the second hypervisor has been discovered, refresh a hypervisor inventory to include identification information associated with the second hypervisor;
if the second hypervisor has not been discovered, discover the second hypervisor;
detect the virtual machine;
associate the virtual machine with the second hypervisor; and
monitor the power consumption of the virtual machine executed by the second hypervisor on the second physical information handling system.

2. The system of claim 1,
wherein the second physical information handling system includes a baseboard management controller; and
wherein, to monitor the power consumption of the virtual machine executed by the second hypervisor, the management console is further configured to receive, from the baseboard management controller, power consumption information of the second physical information handling system.

3. The system of claim 2, wherein, to monitor the power consumption of the virtual machine executed by the second hypervisor, the management console is further configured to determine the power consumption of the virtual machine executed by the second hypervisor based at least on the power consumption information of the second physical information handling system.

4. The system of claim 3, wherein, to determine the power consumption of the virtual machine executed by the second hypervisor based at least on the power consumption information of the second physical information handling system, the management console is further configured to determine the power consumption of the virtual machine executed by the second hypervisor based at least on a first portion of power of a physical processor of the second physical information handling system utilized by the virtual machine and a second portion of power of physical memory of the second physical information handling system utilized by the virtual machine.

5. The system of claim 2, wherein the baseboard management controller includes:
at least one processor; and
a memory medium, coupled to the at least one processor, that stores instructions executable by the at least one processor, which when executed by the at least one processor, cause the baseboard management controller to:
determine the power consumption information of the second physical information handling system.

6. The system of claim 5,
wherein the baseboard management controller is communicatively coupled to a plurality of busses of the second physical information handling system; and
wherein, to determine the power consumption information of the second physical information handling system, the instructions further cause the baseboard management controller to:
receive information from at least one of the plurality of busses; and
determine the power consumption information of the second physical information handling system based at least on the information from the at least one of the plurality of busses.

7. The system of claim 1,
wherein the virtual machine migration information includes the identification information associated with the second hypervisor; and
wherein, to determine if the second hypervisor has been discovered based at least on the virtual machine migration information, the management console is further configured to determine if the hypervisor inventory includes the identification information associated with the second hypervisor.

8. The system of claim 1, wherein the management console is further configured to:
determine that the second hypervisor is not configured to supply virtual machine metrics associated with the virtual machine; and
in response to determining that the second hypervisor is not configured to supply the virtual machine metrics associated with the virtual machine, configure hypervisor setting of the second hypervisor to supply the virtual machine metrics associated with the virtual machine.

9. The system of claim 1, wherein the management console is further configured to:
determine that the second hypervisor is not capable of determining power consumption data associated with the virtual machine; and
in response to determining that the second hypervisor is not capable of determining the power consumption data associated with the virtual machine, install an agent on the second hypervisor to collect the power consumption data associated with the virtual machine.

10. The system of claim 1, further comprising:
the network.

11. A method, comprising:
monitoring, by a management console, power consumption of a virtual machine executed by a first hypervisor on a first physical information handling system;
migrating, by the management console, the virtual machine from the first hypervisor to a second hypervisor on a second physical information handling system;
providing, by the first hypervisor, virtual machine migration information to the management console;
determining, by the management console, if the second hypervisor has been discovered based at least on the virtual machine migration information;
if the second hypervisor has been discovered:
refreshing a hypervisor inventory to include identification information associated with the second hypervisor;
if the second hypervisor has not been discovered:
discovering the second hypervisor;
detecting the virtual machine;
associating the virtual machine with the second hypervisor; and
monitoring, by the management console, the power consumption of the virtual machine executed by the second hypervisor on the second physical information handling system.

12. The method of claim 11, wherein the monitoring the power consumption of the virtual machine executed by the second hypervisor includes receiving, from a baseboard management controller of the second physical information handling system, power consumption information of the second physical information handling system.

13. The method of claim 12, wherein the monitoring the power consumption of the virtual machine executed by the second hypervisor includes determining the power consumption of the virtual machine executed by the second hypervisor based at least on the power consumption information of the second physical information handling system.

14. The method of claim 13, wherein the determining the power consumption of the virtual machine executed by the second hypervisor based at least on the power consumption information of the second physical information handling system includes determining the power consumption of the virtual machine executed by the second hypervisor based at least on a first portion of power of a physical processor of the second physical information handling system utilized by the virtual machine and a second portion of power of physical memory of the second physical information handling system utilized by the virtual machine.

15. The system of claim 12, further comprising:
determining, by the baseboard management controller, the power consumption information of the second physical information handling system.

16. The method of claim 15,
wherein the baseboard management controller is communicatively coupled to a plurality of busses of the second physical information handling system; and
wherein the determining the power consumption information of the second physical information handling system includes:
receiving, by the baseboard management controller, information from at least one of the plurality of busses; and
determining, by the baseboard management controller, the power consumption information of the second physical information handling system based at least on the information from the at least one of the plurality of busses.

17. The method of claim 11,
wherein the virtual machine migration information includes the identification information associated with the second hypervisor; and
wherein the determining if the second hypervisor has been discovered based at least on the virtual machine migration information includes determining if the hypervisor inventory includes the identification information associated with the second hypervisor.

18. The method of claim 11, further comprising:
determining that the second hypervisor is not configured to supply virtual machine metrics associated with the virtual machine; and
in response to the determining that the second hypervisor is not configured to supply the virtual machine metrics associated with the virtual machine, configuring hypervisor setting of the second hypervisor to supply the virtual machine metrics associated with the virtual machine.

19. The method of claim 11, further comprising:
determining that the second hypervisor is not capable of determining power consumption data associated with the virtual machine; and
in response to the determining that the second hypervisor is not capable of determining the power consumption data associated with the virtual machine, installing an agent on the second hypervisor to collect the power consumption data associated with the virtual machine.

20. The method of claim 11,
wherein the first physical information handling system and the second physical information handling system are communicatively coupled to a network; and
wherein the migrating, by the management console, the virtual machine from the first hypervisor to the second hypervisor on the second physical information handling system includes causing the first physical information handling system to migrate the virtual machine to the second physical information handling system via the network.
